(19) United States
(12) Patent Application Publication
(10) Pub. No.: US 2026/0147209 A1
(43) Pub. Date: May 28, 2026

(54) OPTICAL SYSTEMS INCLUDING TWO-DIMENSIONAL EXPANSION LIGHT-GUIDE OPTICAL ELEMENTS WITH INTERMEDIATE EXPANSION REGION

(71) Applicant: LUMUS LTD., Ness Ziona (IL)

(72) Inventors: Elad SHARLIN, Mishmar David (IL); Yochay DANZIGER, Kfar Vradim (IL)

(21) Appl. No.: 19/123,793

(22) PCT Filed: Sep. 28, 2023
(86) PCT No.: PCT/IL2023/051044

§ 371 Date: Apr. 24, 2025

Related U.S. Application Data
(60) Provisional application No. 63/426,753, filed on Nov. 20, 2022.

(51) Int. Cl. G02B 27/01; G02B 5/18; G02B 27/00

(52) U.S. Cl. CPC G02B 27/0172; G02B 5/1814; G02B 5/1842; G02B 27/0081; G02B 2027/0112; G02B 2027/0125; G02B 2027/0174; G02B 2027/0178

(57) ABSTRACT

An LOE has a first region with a first set of facets, and a second region with a second set of facets at a different orientation from the first set. Both sets of facets are located between a set of parallel major external surfaces. An intermediate region between the faceted regions has a diffractive optical aperture expansion configuration. Image illumination introduced into the LOE from an image projector propagates along the LOE, is redirected by the first set of facets to the intermediate region to expand an optical aperture of the image projector in a first dimension, where the image illumination is deflected to the second region by the diffractive optical aperture expansion configuration such that the optical aperture is further expanded in the first dimension. The image illumination is then coupled out of the LOE by the second set of facets, expanding the optical aperture in a second dimension.

### CROSS-REFERENCE TO RELATED APPLICATIONS

This application claims priority from U.S. Provisional Patent Application Ser. No. 63/426,753, filed Nov. 20, 2022, whose disclosure is incorporated by reference in its entirety herein.

### TECHNICAL FIELD

The present disclosure relates to optical systems, and, in particular, it concerns an optical system including a light-guide optical element (LOE) for achieving optical aperture expansion.

### BACKGROUND OF THE INVENTION

Optical arrangements for near eye display (NED), head mounted display (HMD) and head up display (HUD) require large aperture to cover the area where the observer's (user's) eye is located (commonly referred to as the eye-motion box—or EMB). In order to implement a compact device, the image that is to be projected into the observer's eye is generated by a small optical image generator (projector) having a small optical aperture. The image from the image projector is conveyed to the eye by an LOE, which expands (multiplies) the image to generate a large aperture.

In order to achieve uniformity of the viewed image, the LOE should be uniformly “filled” with the projected image and its conjugate image. This imposes design limitations on the size of the image projector and various other aspects of the optical design.

### SUMMARY OF THE INVENTION

The present disclosure provides one or more optical system each having at least one light-guide optical element (LOE) for directing image illumination from an image projector to an eye-motion box for viewing by an eye of a user.

According to the teachings of an embodiment of the present disclosure, there is provided a light-guide optical element (LOE) for directing image illumination from an image projector to an eye-motion box for viewing by an eye of a user. The LOE is formed from transparent material and comprises: a first region containing a first optical aperture expansion configuration including a first set of planar, mutually-parallel, partially reflecting surfaces having a first orientation; a second region containing a second optical aperture expansion configuration including a second set of planar, mutually-parallel, partially reflecting surfaces having a second orientation non-parallel to the first orientation; an intermediate region, located between the first and second regions, having a diffractive optical aperture expansion configuration including at least one diffractive element; and a pair of mutually-parallel major external surfaces, the major external surfaces extending across the first and second regions such that both the first set of partially-reflecting surfaces and the second set of partially-reflecting surfaces are located between the major external surfaces, the image illumination from the image projector propagating by internal reflection at the major external surfaces. The optical aperture expansion configurations are configured such that, image illumination injected into the LOE that propagates by internal reflection at the major external surfaces is deflected by the first optical aperture expansion configuration to the intermediate region so as to expand an optical aperture of the image projector in a first dimension, where the image illumination is deflected by the diffractive optical aperture expansion configuration to the second region so as to further expand the optical aperture of the image projector in the first dimension, and where the image illumination is deflected by the second optical aperture expansion configuration so that the image illumination is coupled out of the LOE toward the eye-motion box and the optical aperture of the image projector is expanded in a second dimension.

Optionally, the diffractive optical aperture expansion configuration is configured to expand the optical aperture of the image projector in the second dimension.

Optionally, the at least one diffractive element is located at a midplane of the LOE that is parallel to the major external surfaces.

Optionally, the at least one diffractive element is configured to deflect a first color of the image illumination at a right-angle, and to deflect a second color of the image illumination at slightly less than a right-angle, and to deflect a third color of the image illumination at slightly more than a right-angle.

Optionally, the at least one diffractive element is located at one of the major external surfaces.

Optionally, the at least one diffractive element is located at the one of the major external surfaces as a surface relief grating.

Optionally, the at least one diffractive element includes a first diffractive element located at a first of the major external surfaces and a second diffractive element located at a second of the major external surfaces.

Optionally, the first diffractive element is located at the first of the major external surfaces as a first surface relief grating, and the second diffractive element is located at the second of the major external surfaces as a second surface relief grating.

Optionally, the first diffractive element and the second diffractive element have a same grating orientation and pitch.

Optionally, the first diffractive element is configured to diffract image illumination of a first color and image illumination of a second color, and the second diffractive element is configured to diffract image illumination of the first color and image illumination of a third color.

Optionally, the first diffractive element and the second diffractive element have a same grating orientation and pitch but have different grating shapes.

Optionally, the diffractive optical aperture expansion configuration is configured to deflect image illumination propagating by internal reflection between the major external surfaces from the third region to the second region at approximately a right-angle.

Optionally, the second region is offset from the first region and the intermediate region along the first dimension.

Optionally, image illumination propagates by total internal reflection (TIR) between the major external surfaces in the intermediate region and encounters the diffractive optical aperture expansion configuration twice in a single TIR roundtrip.

Optionally, image illumination propagates by total internal reflection (TIR) between the major external surfaces in the intermediate region and encounters the diffractive optical aperture expansion configuration once in a single TIR roundtrip.

Optionally, the LOE further comprises: a second pair of mutually-parallel major external surfaces forming a rectangular cross-section at the first region such that the image illumination injected into the LOE advances through the first region by four-fold internal reflection at the two pairs of major external surfaces.

There is also provided according to the teachings of an embodiment of the present disclosure a light-guide optical element (LOE) for directing image illumination from an image projector to an eye-motion box for viewing by an eye of a user. The LOE is formed from transparent material and comprises: a first region containing a first set of planar, mutually-parallel, partially reflecting surfaces; a second region containing a second set of planar, mutually-parallel, partially reflecting surfaces; a third region containing a third set of planar, mutually-parallel, partially reflecting surfaces; and a pair of mutually-parallel major external surfaces, the major external surfaces extending across the first region, the second region, and the third region such that the first, second, and third sets of partially-reflecting surfaces and the second set of partially-reflecting surfaces are located between the major external surfaces, the image illumination from the image projector propagating by internal reflection at the major external surfaces. The third set of partially reflecting surfaces are oriented non-parallel to the first set of partially reflecting surfaces, and the second set of partially reflecting surfaces are oriented non-parallel to the third set of partially reflecting surfaces, and the first set of partially reflecting surfaces, the second set of partially reflecting surfaces, and the third set of partially reflecting surfaces are configured such that, image illumination injected into the LOE that propagates by internal reflection at the major external surfaces is deflected by the first set of partially reflecting surfaces to the second region so as to expand an optical aperture of the image projector in a first dimension, where the image illumination is deflected by the second set of partially reflecting surfaces to the third region so as to further expand the optical aperture of the image projector in the first dimension, and where the image illumination is deflected by the third set of partially reflecting surfaces so that the image illumination is coupled out of the LOE toward the eye-motion box and the optical aperture of the image projector is expanded in a second dimension.

Optionally, the second set of partially reflecting surfaces are perpendicular to the major external surfaces.

Optionally, the second set of partially reflecting surfaces are oblique to the major external surfaces.

There is also provided according to the teachings of an embodiment of the present disclosure an optical system. The optical system comprises: an LOE according to the teachings of any of the above discussed embodiments; and an image projector configured to project image illumination corresponding to a collimated image and being optically coupled to the LOE so as to inject the image illumination into the first region of the LOE so as to propagate within the LOE by internal reflection at the major external surfaces.

There is also provided according to the teachings of an embodiment of the present disclosure an optical system for directing image illumination to an eye-motion box for viewing by an eye of a user. The optical system comprises: an image projector having an optical aperture and being configured to project image illumination corresponding to a collimated image; and a light-guide optical element (LOE) formed from transparent material and being optically coupled to the image projector. The LOE comprises: a first major external surface and a second major external surface, the first and second major external surfaces being mutually parallel, the image illumination from the image projector propagating by internal reflection at the major external surfaces, a first region containing a first optical aperture expansion configuration including a first set of planar, mutually-parallel, partially reflecting surfaces having a first orientation, a second region containing a second optical aperture expansion configuration including a second set of planar, mutually-parallel, partially reflecting surfaces having a second orientation non-parallel to the first orientation, and an intermediate region, located between the first and second regions, having a diffractive optical aperture expansion configuration including a first diffractive element located at the first major external surface and a second diffractive element located at the second major external surface such that the first and second diffractive elements are parallel. The major external surfaces extend across the first and second regions such that both the first set of partially-reflecting surfaces and the second set of partially-reflecting surfaces are located between the major external surfaces. The optical aperture expansion configurations are configured such that, image illumination injected into the LOE that propagates by internal reflection at the major external surfaces is deflected by the first optical aperture expansion configuration to the intermediate region so as to expand an optical aperture of the image projector in a first dimension, where the image illumination is deflected by the diffractive optical aperture expansion configuration to the second region so as to further expand the optical aperture of the image projector in the first dimension, and where the image illumination is deflected by the second optical aperture expansion configuration so that the image illumination is coupled out of the LOE toward the eye-motion box and the optical aperture of the image projector is expanded in a second dimension.

Within the context of this document, the term “guided” generally refers to light that is trapped within a light-transmitting material (e.g., a substrate) by internal reflection at major external surfaces of the light-transmitting material, such that the light that is trapped within the light-transmitting material propagates in a propagation direction through the light-transmitting material. Light propagating within the light-transmitting substrate is trapped by internal reflection when the propagating light is incident to major external surfaces of the light-transmitting material at angles of incidence that are within a particular angular range. The internal reflection of the trapped light may be in the form of total internal reflection, whereby propagating light that is incident to major external surfaces of the light-transmitting material at angles greater than a critical angle (defined in part by the refractive index of the light-transmitting material and the refractive index of the medium surrounding the light-transmitting, e.g., air) is totally internally reflected at the major external surfaces. Alternatively, the internal reflection of the trapped light may be effectuated by a coating, such as an angularly selective reflective coating, applied to the major external surfaces of the light-transmitting material to achieve reflection of light that is incident to the major external surfaces within the particular angular range.

Unless otherwise defined herein, all technical and/or scientific terms used herein have the same meaning as commonly understood by one of ordinary skill in the art to which the disclosure pertains. Although methods and materials similar or equivalent to those described herein may be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosure are herein described, by way of example only, with reference to the accompanying drawings. With specific reference to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Attention is now directed to the drawings, where like reference numerals or characters indicate corresponding or like components. In the drawings:

FIG. 1 is a schematic isometric view of a device having a pair of optical systems, each implemented using a light-guide optical element (LOE), constructed and operative according to the teachings of an embodiment of the present disclosure;

FIGS. 2A and 2B are schematic front and side views, respectively, illustrating an LOE having a set of major external surfaces, two regions each containing a set of partially reflecting surfaces (facets) between the major external surfaces, and an intermediate region located between the two faceted regions having an intermediate beam expansion configuration implemented as a diffractive arrangement having a diffractive element located at a midplane of the LOE, according to an embodiment of the present disclosure;

FIGS. 3A and 3B are schematic front and side views, respectively, similar to FIGS. 2A and 2B, but with a single diffractive element located at one of the major external surfaces of the LOE, according to an embodiment of the present disclosure;

FIG. 4 is a schematic side view similar to FIG. 3B, but with the diffractive arrangement having a pair of parallel diffractive elements, each diffractive element located at a respective one of the major external surfaces of the LOE, according to an embodiment of the present disclosure;

FIG. 5 is an enlarged schematic front view of the diffractive arrangement of the LOE, showing the path of the different color components of a principal ray that is incident to the diffractive arrangement, according to an embodiment of the present disclosure;

FIG. 6 is a schematic front view similar to FIG. 2A, but with the intermediate beam expansion configuration implemented as a set of partially reflecting surfaces between the major external surfaces, according to an embodiment of the present disclosure; and

FIG. 7 is a schematic side view, similar to FIG. 2B, but with the set of major external surfaces at the first faceted region including two pairs of major external surfaces forming a rectangular cross-section, according to an embodiment of the present disclosure.

### DESCRIPTION OF THE PREFERRED EMBODIMENTS

Certain embodiments of the present disclosure provide a light-guide optical element (LOE), and an optical system including one or more LOE, for achieving optical aperture expansion for the purpose of a head-up display, and most preferably a near-eye display, which may be a virtual reality display, or more preferably an augmented reality display.

The principles and operation of the optical system and LOE according to the present disclosure may be better understood with reference to the drawings accompanying the description.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the examples. The disclosure is capable of other embodiments or of being practiced or carried out in various ways.

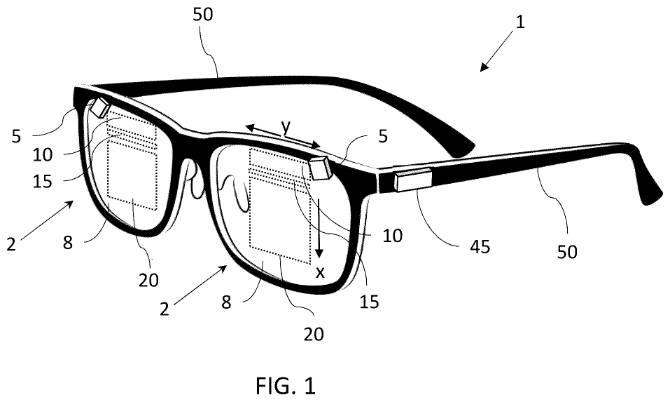

Referring now to the drawings, FIG. 1 schematically illustrates an exemplary implementation of a device a near-eye display, generally designated 1, employing a pair of optical systems 2, one for each eye, according to the teachings of an embodiment of the present disclosure. Each optical system 2 employs an LOE 8 and a compact image projector (a “projection optical device” or “POD”) 5 optically coupled with the LOE 8 so as to inject an image into the LOE (interchangeably referred to as a “waveguide,” a “substrate” or a “slab”) 8 within which the image light (illumination) is trapped by internal reflection at a set of mutually-parallel planar major external surfaces. In most of the embodiments described herein, the image light is trapped in one dimension. However, embodiments will be described in which the image light is trapped in two dimensions.

Optical coupling of the POD 5 to the LOE 8 may be achieved by any suitable optical coupling, such as for example via a coupling prism with an obliquely angled input surface, or via a reflective coupling arrangement, via a side edge and/or one of the major external surface of the LOE. Details of the coupling-in arrangement are not critical to the disclosure, and therefore are not shown here.

The LOE 8 has three distinct regions (also referred to as “sections”) each having an associated optical aperture expansion configuration (also referred to as “beam expanders”). The three regions are designated as 10, 20, and 15.

It is noted that in some of the appended claims, the term “first region” refers to region 10, the term “second region” refers to region 20, and the term “intermediate region” refers to region 15, whereas in other of the appended claims, the term “first region” refers to region 10, the term “second region” refers to region 15, and the term “third region” refers to region 20.

Region 10 has a direction of elongation, corresponding in FIG. 1 to the Y direction. Region 15 is located between (i.e., interposed between) the two regions 10 and 20. The LOE 8 also includes a fourth region 9, also referred to as a “coupling-in” region 9, which is generally defined as the region of the LOE 8 at which the image from the POD 5 is introduced into the LOE 8 (i.e., the region of the LOE 8 at which the coupling-in arrangement is optically coupled).

The injected image light traverses through the LOE 8 by internal reflection at the major external surfaces and impinges on a first optical expansion configuration that includes a set of partially-reflecting surfaces (interchangeably referred to as “facets”) that are parallel to each other, and inclined obliquely to the direction of propagation of the image light, with each successive facet deflecting a proportion of the image light into a deflected direction, also trapped/guided by internal reflection within the substrate. This first set of facets are not illustrated individually in FIG. 1, but are located in region 10 of the LOE 8. This partial reflection at successive facets expands the optical aperture of the POD 5 in a first dimension (referred to as a “lateral” dimension), which corresponds here to the direction of elongation of region 10. In other words, this partial reflection at successive facets achieves a first dimension of optical aperture expansion.

In a first set of preferred but non-limiting examples of the present disclosure, the aforementioned set of facets are orthogonal to the major external surfaces of the substrate. In this case, both the injected image and its conjugate undergoing internal reflection as it propagates within region 10 are deflected and become conjugate images propagating in a deflected direction. In an alternative set of preferred but non-limiting examples, the first set of partially-reflecting surfaces are obliquely angled relative to the major external surfaces of the LOE 8. In the latter case, either the injected image or its conjugate forms the desired deflected image propagating within the LOE 8, while the other reflection may be minimized, for example, by employing angularly-selective coatings on the facets which render them relatively transparent to the range of incident angles presented by the image whose reflection is not needed.

The first set of partially-reflecting surfaces deflect the image illumination from region 10, propagating in a first direction of propagation trapped by total internal reflection (TIR) within the substrate, to region 15, where the image illumination propagates in a second direction of propagation and is also trapped by TIR within the substrate. Region 15 has an intermediate optical expansion configuration, the details of which will be described later, which deflects the image illumination propagating from region 10 to region 15, propagating in the second direction, to region 20 and further expands the optical aperture in the first dimension, wherein the image illumination propagates in another direction of propagation and is also trapped by TIR within the substrate. Region 20 contains a second optical expansion configuration that is an optical coupling-out arrangement, implemented as a further set of partially reflective facets, which progressively couples out a proportion of the image illumination towards the eye of an observer located within a region defined as the eye-motion box (EMB), thereby achieving a second dimension of optical aperture expansion.

Each of the LOE regions may be formed as a distinct substrate or may be a continuation of a single substrate. For example, in a preferred but non-limiting implementation, the three regions 10, 15, 20 are contained within a single substrate. Regardless of the implementation, the pair of major external surfaces of the LOE 8 extend across the three regions 10, 15, 20 such that both sets of partially reflecting surfaces are located between the major external surfaces. Depending on the particular implementation, the intermediate optical expansion configuration may have components located between the major external surfaces, or may have components located on one or both of the major external surfaces.

Regarding the size of the aperture of POD 5 and the coupling-in arrangement, it is possible to implement these to sufficiently “fill” the thickness of the LOE 8 with image illumination in order to achieve lateral uniformity of the viewed image. However, this typically requires an aperture which is roughly twice the dimension of the input aperture of LOE 8. In order to minimize the dimensions of the POD 5, particularly the lateral dimension of the POD 5, it may be preferable to provide a reduced-sized projector aperture that does not achieve filling of the LOE 8. In this case, the facets in region 10 may be configured such that the first dimensional aperture expansion achieved by the facets is a partial expansion, i.e., the deflected illumination is not uniform in the first (lateral) dimension. High-uniformity of the output image in the lateral dimension can be achieved by the intermediate optical expansion configuration (in region 15) which completes the lateral expansion of the image performed by the facets in region 10 and produces a uniform image in the lateral dimension.

As illustrated in FIG. 1, the overall device 1 may be implemented to carry a pair of optical systems 2, one separately for each eye, and is preferably supported relative to the head of a user (also reviewed as a “viewer”) with the each LOE 8 facing a corresponding eye of the user. In one particularly preferred option as illustrated here, a support arrangement is implemented as an eye glasses frame with sides (or “arms”) 50 for supporting the device 1 relative to ears of the user such that one of the major external surfaces is in facing relation to an eye of the user. Other forms of support arrangement may also be used, including but not limited to, head bands, visors or devices suspended from helmets.

Reference is made herein in the drawings and to a Y axis which extends horizontally (FIG. 1), in the general extensional direction of region 10 of the LOE 8, and an X axis which extends perpendicular thereto, i.e., vertically in FIG. 1.

In very approximate terms, region 10, may be considered to achieve aperture expansion in the Y direction (which is the so-called first (lateral) dimension, which coincides with the direction of elongation of region 10) while region 20, achieves aperture expansion in the X direction (which is the so-called second (vertical) dimension). The details of the spread of angular directions in which different parts of the field of view propagate will be addressed more precisely below. It should be noted that the orientation as illustrated in FIG. 1 may be regarded as a “top-down” implementation, where the image illumination entering the main region (region) of the LOE enters from the top edge. However, other implementations, such as a “side-injection” implementation, where the axis referred to here as the Y axis is deployed vertically, or other intermediate orientations, are also contemplated herein and fall within the scope of the present disclosure except where explicitly excluded.

The POD 5 employed with the device 1 of the present disclosure is preferably configured to generate a collimated image, i.e., in which the light of each image pixel is a parallel beam, collimated to infinity, with an angular direction corresponding to the pixel position. The image illumination thus spans a range of angles corresponding to an angular field of view in two dimensions. The POD 5 includes at least one light source, typically deployed to illuminate a spatial light modulator, such as an LCOS chip. The spatial light modulator modulates the projected intensity of each pixel of the image, thereby generating an image. Alternatively, the image projector may include a scanning arrangement, typically implemented using a fast-scanning mirror, which scans illumination from a laser light source across an image plane of the projector while the intensity of the beam is varied synchronously with the motion on a pixel-by-pixel basis, thereby projecting a desired intensity for each pixel. In both cases, collimating optics are provided to generate an output projected image which is collimated to infinity. Some or all of the above components are typically arranged on surfaces of one or more polarizing beam-splitter (PBS) cube or other prism arrangement, as is well known in the art.

It will be appreciated that the near-eye display 1 includes various additional components, typically including a controller 45 for actuating the image projector 5, typically employing electrical power from a small onboard battery (not shown) or some other suitable power source. It will be appreciated that controller 40 includes all necessary electronic components such as at least one processor or processing circuitry to drive the image projector, all as is known in the art.

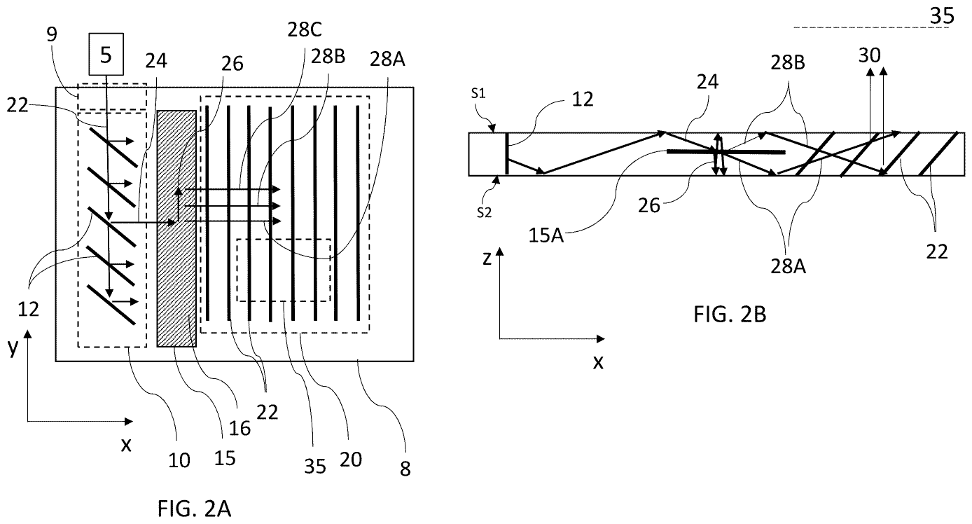

Turning now to FIGS. 2A and 2B, the optical properties of an embodiment of the near-eye display are illustrated in more detail. Specifically, there is shown a more detailed view of a light-guide optical element (LOE) 8, formed from transparent material, that includes a region 10 containing a first optical aperture expansion configuration that includes a set of planar, mutually-parallel, partially-reflecting surfaces (facets) 12 having an orientation, and a region 20 containing a second optical aperture expansion configuration that includes a set of planar, mutually-parallel, partially-reflecting surfaces (facets) 22 having an orientation that non-parallel to the orientation of the facets 12. The LOE 8 also includes an intermediate region 15, interposed between the two regions 10 and 20, having or containing an intermediate optical aperture expansion configuration 16.

A set of mutually-parallel major external surfaces s1 and s2 extend across the regions 10, 15, and 20 such that both sets of partially-reflecting surfaces 12 and 22 are located between the major external surfaces s1 and s2. In the illustrated embodiment, the set of major external surfaces s1 and s2 is a pair of surfaces which are each continuous across the entirety of regions 10 and 20, although the option of having a set down or a step up in thickness between regions 10 and 20 also falls within the scope of the present disclosure. Each of the pairs of adjacent regions 10 and 15 and the pairs of adjacent regions 15 and 20 may be immediately juxtaposed so that they meet at a boundary, which may be a straight boundary or some other form of boundary, or there may be one or more additional LOE region interposed between those regions, to provide various additional optical or mechanical function, depending upon the particular application.

The near-eye display is designed to provide a full field-of-view of the projected image from the POD 5 to an eye of the user that is located at some position within a permitted range of positions designated by an “eye-motion box” (EMB) 35 (that is, a shape, typically represented as a rectangle, spaced away from the plane of the LOE from which the pupil of the eye will view the projected image). The optical properties of the LOE 8 may be better understood by tracing the image illumination path from the POD 5 to the EMB 35.

The POD 5 injects beam 22 into the LOE 8 at coupling-in region 9 of the LOE 8 by way of a suitable coupling-in arrangement (which as previously mentioned may be a coupling prism, coupling reflector, etc.). As discussed above, the image illumination produced by the POD 5 spans a range of angles corresponding to an angular field of view in two dimensions, where each angular direction corresponds to a pixel position. Thus, the beam 22 is representative of a plurality of beams that make up the collimated image.

The injected beam (image illumination) 22 propagates in the LOE 8 by internal reflection at the major external surfaces s1 and s2. As the beam 22 propagates in the LOE 8, it enters region 10 of the LOE 8 from the region 9 and encounters the partially-reflecting surfaces 12 which are embedded between the major external surfaces s1 and s2. These partially-reflecting surfaces 12 are oriented so that a part of the image illumination 22, propagating within the LOE 8 by internal reflection at the major external surfaces s1 and s2 from the coupling-in region 9 of the LOE 8, is deflected so as to enter region 15. In principle, the partially-reflecting surfaces 12 reflect multiple beams originated from the beam 22, but for clarity of illustration, only one of the deflected/reflected beams, designated 24, is shown in FIGS. 2A and 2B. The deflection of the image illumination is such that the image illumination is deflected from a first direction of propagation to a second direction of propagation, and such that the original optical aperture defined by the POD 5 is expanded in a first (lateral) dimension.

Region 15 contains the intermediate optical aperture expansion configuration 16 that diffracts the beam 24 at approximately a right angle (to be discussed later). In the illustrated embodiment, the intermediate optical aperture expansion configuration 16 is implemented as a diffractive optical aperture expansion configuration having a diffractive arrangement that includes a diffractive optical element (DOE) 15A (FIG. 2B) that is embedded within the LOE 8 between the major external surfaces s1 and s2, and in particular at a midplane of the LOE 8 that is parallel to the major external surfaces s1 and s2. As a result, the propagating beam 24 will encounter the DOE 15A twice in a single TIR roundtrip.

As illustrated in FIG. 2B, the beam 24 encounters the DOE 15A where part of the beam 24 (i.e., a proportion of the intensity of the beam) is diffracted as beam 26 and another part of the beam 24 continues as beam 28A. The diffracted beam 26 is reflected by TIR at the major external surfaces s1 and s2 so that it also encounters the DOE 15A, where part of the beam 26 is diffracted as beam 28B which is parallel to beam 28A. The beam 26 continues to generate additional parallel beams, only one of which, designated 28C, is illustrated in the drawings (FIG. 2A) for the sake of clarity and conciseness. The set of parallel beams 28A, 28B, 28C, etc. are an expansion of the beam 24. The expansion is a two-dimensional expansion, i.e., an expansion in the first dimension (i.e., lateral dimension, approximately in the Y direction), as shown in FIG. 2A, and an expansion in a second dimension (i.e., vertical dimension, approximately in the X direction), as shown in FIG. 2B. The expansion in the lateral dimension is supplementary to the lateral expansion performed by the partially-reflecting surfaces 12 so that the image illumination is uniform in the first dimension. Thus, in effect, the diffractions performed by the DOE 15A complete the partial lateral expansion imparted by the partially-reflecting surfaces 12.

The DOES 15A performs two diffractions. Specifically, the DOE 15A performs a first diffraction of the beam 24 (which is propagating in an input direction) to redirect (deflect) the beam 24 as beam 26 in a first direction non-parallel to the input direction (approximately at a right angle), and performs a second diffraction of the beam 26 to redirect (deflect) the beam 26 as beams 28B, 28C, etc. in a second direction parallel to the input direction while expanding the illumination laterally. The DOE 15A is implemented as a strongly diffracting element, such that the diffraction performed to redirect (deflect) beam 26 to beams 28B, 28C, etc. is a strong diffraction which allows the DOE 15A to achieve the expansion in the lateral dimension.

In addition to expanding the optical aperture, the diffraction of the image illumination 24 by the intermediate optical aperture expansion configuration 16 causes the image illumination, propagating in region 15, to be redirected (deflected) into region 20. Thus, the beams 28A, 28B, 28C, etc., generated by the intermediate optical aperture expansion configuration 16, enter region 20, where they continue to propagate by internal reflection at the major external surfaces s1 and s2. As the beams 28A, 28B, 28C, etc. propagate in region 20 of the LOE 8, they encounter the partially-reflecting surfaces 22 which are embedded between the major external surfaces s1 and s2. These partially-reflecting surfaces 22 are oriented to be inclined obliquely to the major external surfaces s1 and s2 such that a part of the image illumination (i.e., a proportion of the intensity of the beams 28A, 28B, 28C, etc.), propagating by internal reflection at the major external surfaces s1 and s2, is deflected so as to be coupled out of the LOE 8 as beams 30 towards the EMB 35. The deflection by the partially-reflecting surfaces 22 is also such that the optical aperture defined by the POD 5 is expanded in the second dimension (vertical dimension, approximately in the X direction).

In practical implementations of the embodiment illustrated in FIGS. 2A and 2B, the DOE 15A should be designed to have a width and diffraction efficiency so that a substantially amount of energy (intensity) is transferred from the beam 28A (which is a continuation of the beam 24, also referred to as a zero order). Practically, it is preferred that more than 50% of the energy (intensity) be diverted from the beam 28A to the other parallel beams generated by the DOE 15A (e.g., beams 28B, 28C, etc.).

It is noted that the lateral spacing between the sets of parallel beams 28A, 28B, 28C, etc. should be taken into consideration when designing the location of the EMB 35. The location of the EMB 35 is dictated by the position of region 20, and more particularly the position of the partially-reflecting surfaces 22, relative to the other two sections/regions 10, 15 of the LOE 8. In order for the near-eye display to provide a full field-of-view of the projected image from the POD 5 to the user's eye, region 20 should be offset from the other two regions 10 and 15 along the first (lateral) dimension (i.e., along the Y direction). For example, a central portion of region 20, for example taken as a bisecting line through region 20 along the X direction in FIG. 2A, can be laterally offset (in FIG. 2A along the Y direction) from a central portion of region 10 (for example taken as a bisecting line through region 10 along the X direction in FIG. 2A) and from a central portion of region 15 (for example taken as a bisecting line through region 15 along the X direction in FIG. 2A). The amount of the lateral offset is based on the lateral spacing between the beams 28A, 28B, 28C, etc. In particular, the offset should be approximately the distance the beam travels through the intermediate optical aperture expansion configuration 16 until its intensity is approximately half (i.e., 50%) of its original intensity.

The embodiment illustrated in FIGS. 2A and 2B provides an advantage in optical performance in that the intermediate optical aperture expansion configuration 16 performs aperture expansion in both lateral and vertical dimensions, and in that the lateral spacing between the generated beams 28A, 28B, 28C, etc. is relatively small effectuating a correspondingly relatively small lateral offset of region 20 relative to regions 10 and 15 which can result in a more compact optical device. However, fabricating a substrate with a diffractive surface embedded within a substrate, in particular at the midplane of the substrate, can be challenging. In practice, it may be simpler to provide diffractive elements on the major external surfaces of the substrate rather than at a midplane of the substrate.

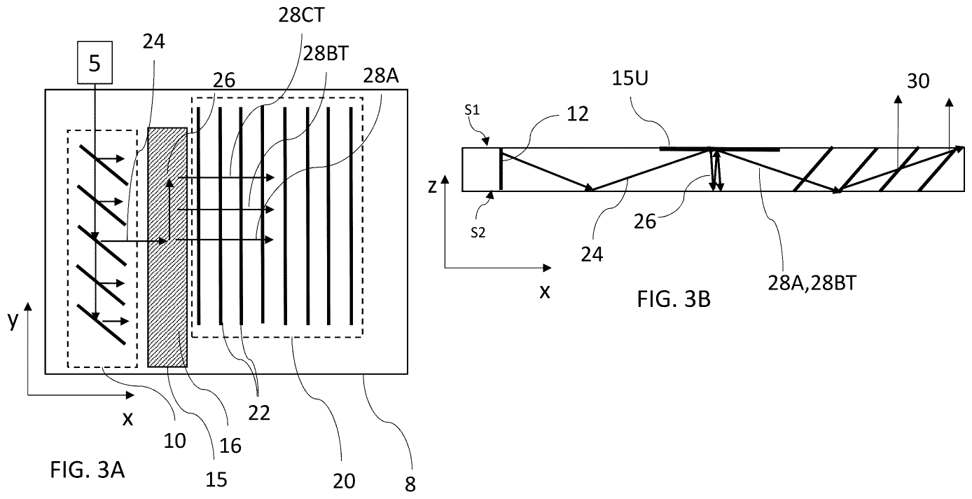

Certain non-limiting embodiments of the present disclosure provide an intermediate optical aperture expansion configuration 16 having a diffractive arrangement implemented as a diffractive element located on one of the major external surfaces s1 or s2, which support simpler fabrication processing. With continued reference to FIGS. 1-2B, refer now to FIGS. 3A and 3B which show an embodiment of the LOE 8 in which the intermediate optical aperture expansion configuration 16 has a diffractive arrangement that includes a DOE 15U located on one of the major external surfaces s1, for example as a surface relief grating. The major external surface s1 is referred to arbitrarily as the “top” or “upper” surface of the LOE 8. Note that the selection of the surface s1 is arbitrary, and the DOE may just as easily be located on the other major external surface s2.

In the embodiment illustrated in FIGS. 3A and 3B, the guided beams 24 and 26 interact with the DOE 15U only once every TIR roundtrip, as opposed to the double-interaction in the embodiment illustrated in FIGS. 2A and 2B. As a consequence, the lateral spacing between the deflected beams 28A, 28BT, 28CT, etc. is twice the spacing as that between the beams 28A, 28B, 28C, etc. in FIG. 2A, which may result in less uniformity in the lateral dimension as compared to the embodiment illustrated in FIGS. 2A and 2B. In addition, this increase in lateral spacing dictates a larger aperture offset to accommodate placement of the EMB, as shown in FIG. 3A, whereby region 20 and the partially-reflecting surfaces 22 are shifted further upwards along the Y direction as compared to their counterparts in FIG. 2A.

Furthermore, since the intermediate optical aperture expansion configuration 16 of FIGS. 3A and 3B includes a DOE 15U deployed at only one of the major external surfaces s1, the intermediate optical aperture expansion configuration 16 only generates lateral beam multiplication, i.e., the intermediate optical aperture expansion configuration 16 only achieves optical aperture expansion in the first (lateral) dimension, but does not achieve optical aperture expansion in the second (vertical) dimension.

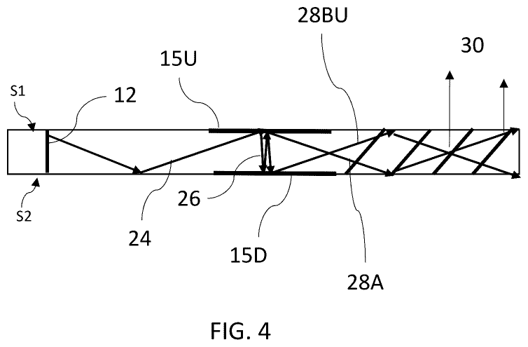

In order to achieve both lateral and vertical optical aperture expansion, and tighter lateral spacing between the beams, a second DOE can be located on the other major external surface. FIG. 4 illustrates such an embodiment, whereby the diffractive arrangement of the intermediate optical aperture expansion configuration 16 includes a second DOE 15D, located on the major external surface s2, such that the two DOEs 15U and 15D are parallel gratings, by virtue of their deployment on parallel surfaces s1 and s2, and thus the two DOEs 15U and 15D have the same grating orientation and pitch. The major external surface s2 is referred to arbitrarily as the “bottom” or “lower” surface of the LOE 8. In the illustrated embodiment, the DOE 15D is located at the major external surface s2 as a surface relief grating. As a consequence of the use of parallel DOEs 15U and 15D, the beams 24 and 26 encounter the diffractive arrangement of the intermediate optical aperture expansion configuration 16 twice in a single TIR roundtrip, resulting in a tighter lateral spacing of the parallel beams (28A, 28BU, etc.) that is the same or similar to the spacing achieved in the embodiment illustrated in FIGS. 2A and 2B. Thus, the intermediate optical aperture expansion configuration 16 in the embodiment illustrated in FIG. 4 is by all intents and purposes functionally equivalent to the intermediate optical aperture expansion configuration 16 in the embodiment illustrated FIGS. 2A and 2B, and may be simpler to fabricate.

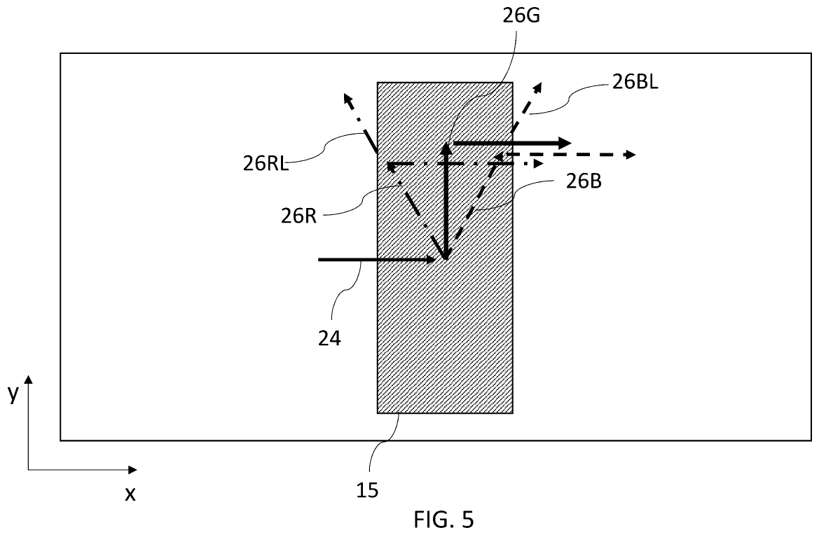

As mentioned above, the intermediate optical aperture expansion configuration 16 performs redirection (deflection) of input beams at approximately a right angle. The variation in the deflection angle, i.e., dispersion, is spectrally dependent, i.e., different color components of the image illumination will be deflected at different angles. In fact, dispersion of the diffracted beam dictates the shape and size of the diffractive elements of the intermediate optical aperture expansion configuration 16. Bearing this in mind, reference is now made to FIG. 5, which schematically illustrates the deflection of different color components of the input image illumination (beam) 24 by the DOE 15A (FIG. 2A). Initially, the beam 24 includes all spectrum of colors of the image (e.g., red, green, and blue). The DOE 15A of FIG. 2B can be designed to redirect (deflect) a first color (e.g., green) of the beam 24 (also referred to as first order) at a right-angle (i.e., 90°), designated as beam 26G. Consequently, the DOE 15A deflects a second color (e.g., blue) of the beam 24 to a slightly lesser angle than a right-angle (in this context “slightly lesser” is approximately 20% less than a right-angle, i.e., approximately 70°), designated as beam 26B, and deflects a third color (e.g., red) of the beam 24 to a slightly larger angle than a right-angle (in this context “slightly larger” is approximately 20% more than a right-angle, i.e., approximately 110°).

The interaction length of the deflected beams can dictate the width (measured along the X direction) of region 15. In particular, the width of region 15 can be designed based on the interaction length of beam 24 needed to deflect approximately 50% of the intensity to beam 26, and the interaction length of beams 26R and 26B needed to minimize residual leaks 26RL and 26BL, respectively.

Improved interaction efficiency (i.e., shorter interaction length for all color components) can be determined by the shape of the diffractive optical element. However, since the configuration of FIGS. 2A and 2B relies on a single DOE 15A, there are inherently fewer degrees of freedom in the diffractive element design as compared with the configuration of FIG. 4 which employs a pair of DOEs 15U and 15D. In certain embodiments, one of the DOEs 15D can be optimized to diffract first and second color components of the image illumination (e.g., green and red) and the other DOE 15U can be optimized to diffract a third color component and the first color component of the image illumination (e.g., blue and green). The optimization is based on maintaining the same periodicity (relief grating pitch and orientation) on both DOEs 15U and 15D but having different grating shape (for example different grating depth) optimized for different spectral regions (red-green and blue-green).

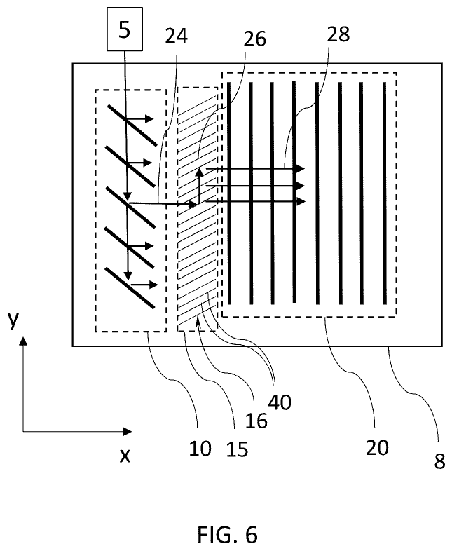

Although the embodiments discussed thus far have pertained to region 15 having an intermediate optical aperture expansion configuration implemented as a diffractive optical aperture expansion configuration, other embodiments are contemplated herein in which the intermediate optical aperture expansion configuration is implemented as a non-diffractive arrangement similar to the arrangements of the optical aperture expansion configurations of the regions 10 and 20. FIG. 6 schematically illustrates one such embodiment in which the intermediate optical aperture expansion configuration 16 is implemented as another set of planar, mutually-parallel, partially-reflecting surfaces (facets) 40 embedded between the major external surfaces s1 and s2, and having an orientation that is non-parallel to the orientation of the facets 22. The third orientation of the facets 40 can be parallel or non-parallel to the orientation of the facets 12. The facets 40 perform a similar function as the diffractive elements described above, in that the facets 40 deflect the beam 26 at approximately a right-angle and back to parallel beams 28, which completes the lateral expansion of the optical aperture of the POD 5 imparted by the facets 12 so that the image illumination is uniform in the first (lateral) dimension. The facets 40 can be deployed perpendicular to the major external surfaces s1 and s2 or oblique to the major external surfaces s1 and s2. In such a configuration, all wavelengths (i.e., color components) of the beam 26 are reflected in the same direction without dispersion. In addition, higher reflectivity of the optical coatings used to implement the facets 40 can enable an even narrower region 15 (narrower being taken along the X direction).

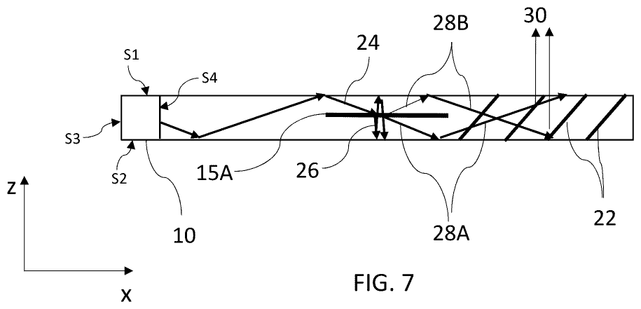

In the embodiments describe thus far, the image illumination that propagates from the coupling-in region 9 to region 10 is trapped in one dimension by internal reflection at the major external surfaces s1 and s2, also referred to as two-fold internal reflection. However, other embodiments are contemplated in which the image illumination that propagates from the coupling-in region 9 to region 10 is trapped in two dimensions. FIG. 7 schematically illustrates an embodiment of an LOE having a region 10 that supports trapping of light in two dimensions. Here, region 10 of the LOE 8 includes two pairs of mutually-parallel planar major external surfaces, namely a first pair of surfaces s1 and s2 and a second pair of major external surfaces s3 and s4. The two pairs of major external surfaces s1, s2, s3, s4 form a rectangular cross-section (which in this configuration is in the XZ plane). In this embodiment, the coupling-in arrangement is such that, when the POD 5 injects image illumination into the LOE 8 at the coupling-in region at an initial direction of propagation at a coupling angle oblique to both first and second pairs of major external surfaces s1, s2, s3, s4, the image illumination advances by four-fold internal reflection along region 10. Region 10 has a direction of elongation, which in this configuration is perpendicular to both the Z and X directions, and the facets in region 10 (not shown in FIG. 7) are inclined obliquely to the direction of elongation. In this embodiment, the first pair of major external surfaces s1 and s2 is still continuous across the other two regions 15 and 20 of the LOE 8, which each supports propagation of light by two-fold internal reflection at the major external surfaces s1 and s2, as in the previously described embodiments. Further details of light-guide optical elements having a first section/region that supports propagation of light by four-fold internal reflection and that has a set of obliquely inclined parallel partial reflectors that progressively couple the image light out of the first section/region, and that has, or is optically coupled with, a second section/region that supports propagation of image light by two-fold internal reflection and progressively couples that image light to a user's eye via a set of parallel partial reflectors, can be found in various commonly owned patent documents, including, U.S. Pat. No. 10,133,070, which is incorporated by reference in its entirety herein.

It should be noted that in all of the configurations described herein, none of the image illumination propagating within the LOE propagates parallel to any of the major external surfaces of the LOE, nor propagates parallel to any of the interacting facets.

Although the embodiments described thus far have pertained to an optical system having an LOE that directs image illumination to an eye, whereby the optical system can be duplicated to support a binocular configuration, embodiments in which a pair of LOEs, each directing image illumination to a corresponding eye, form part of a single overall optical system also fall within the scope of the present disclosure and appended claims. Furthermore, although the embodiments described with reference to FIG. 1 pertain to a binocular type device carrying a pair of optical systems, one for each eye, each carrying a respective LOE for directing image illumination to a corresponding eye, the scope of the present disclosure should not be limited to binocular type devices. A device that is a monocular type device, having an optical system with an LOE for directing image illumination to a single eye only, also falls within the scope of the present disclosure and appended claims.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the disclosure.

Although the disclosure has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A light-guide optical element (LOE) for directing image illumination from an image projector to an eye-motion box for viewing by an eye of a user, the LOE formed from transparent material and comprising:
a first region containing a first optical aperture expansion configuration including a first set of planar, mutually-parallel, partially reflecting surfaces having a first orientation;
a second region containing a second optical aperture expansion configuration including a second set of planar, mutually-parallel, partially reflecting surfaces having a second orientation non-parallel to the first orientation;
an intermediate region, located between the first and second regions, having a diffractive optical aperture expansion configuration including at least one diffractive element; and
a pair of mutually-parallel major external surfaces, the major external surfaces extending across the first and second regions such that both the first set of partially-reflecting surfaces and the second set of partially-reflecting surfaces are located between the major external surfaces, the image illumination from the image projector propagating by internal reflection at the major external surfaces,
wherein the optical aperture expansion configurations are configured such that,
image illumination injected into the LOE that propagates by internal reflection at the major external surfaces is deflected by the first optical aperture expansion configuration to the intermediate region so as to expand an optical aperture of the image projector in a first dimension, where the image illumination is deflected by the diffractive optical aperture expansion configuration to the second region so as to further expand the optical aperture of the image projector in the first dimension, and where the image illumination is deflected by the second optical aperture expansion configuration so that the image illumination is coupled out of the LOE toward the eye-motion box and the optical aperture of the image projector is expanded in a second dimension.

2. The LOE of claim 1, wherein the diffractive optical aperture expansion configuration is configured to expand the optical aperture of the image projector in the second dimension.

3. The LOE of claim 1, wherein the at least one diffractive element is located at a midplane of the LOE that is parallel to the major external surfaces.

4. The LOE of claim 1, wherein the at least one diffractive element is configured to deflect a first color of the image illumination at a right-angle, and to deflect a second color of the image illumination at slightly less than a right-angle, and to deflect a third color of the image illumination at slightly more than a right-angle.

5. The LOE of claim 1, wherein the at least one diffractive element is located at one of the major external surfaces.

6. The LOE of claim 5, wherein the at least one diffractive element is located at the one of the major external surfaces as a surface relief grating.

7. The LOE of claim 1, wherein the at least one diffractive element includes a first diffractive element located at a first of the major external surfaces and a second diffractive element located at a second of the major external surfaces.

8. The LOE of claim 7, wherein the first diffractive element is located at the first of the major external surfaces as a first surface relief grating, and wherein the second diffractive element is located at the second of the major external surfaces as a second surface relief grating.

9. The LOE of claim 7, wherein the first diffractive element and the second diffractive element have a same grating orientation and pitch.

10. The LOE of claim 7, wherein the first diffractive element is configured to diffract image illumination of a first color and image illumination of a second color, and wherein the second diffractive element is configured to diffract image illumination of the first color and image illumination of a third color.

11. The LOE of claim 7, wherein the first diffractive element and the second diffractive element have a same grating orientation and pitch but have different grating shapes.

12. The LOE of claim 1, wherein the diffractive optical aperture expansion configuration is configured to deflect image illumination propagating by internal reflection between the major external surfaces from the third region to the second region at approximately a right-angle.

13. The LOE of claim 1, wherein the second region is offset from the first region and the intermediate region along the first dimension.

14. The LOE of claim 1, wherein image illumination propagates by total internal reflection (TIR) between the major external surfaces in the intermediate region and encounters the diffractive optical aperture expansion configuration twice in a single TIR roundtrip.

15. The LOE of claim 1, wherein image illumination propagates by total internal reflection (TIR) between the major external surfaces in the intermediate region and encounters the diffractive optical aperture expansion configuration once in a single TIR roundtrip.

16. The LOE of claim 1, further comprising: a second pair of mutually-parallel major external surfaces forming a rectangular cross-section at the first region such that the image illumination injected into the LOE advances through the first region by four-fold internal reflection at the two pairs of major external surfaces.

17. An optical system for directing image illumination to an eye-motion box for viewing by an eye of a user, the optical system comprising:
an image projector having an optical aperture and being configured to project image illumination corresponding to a collimated image; and
a light-guide optical element (LOE) formed from transparent material and being optically coupled to the image projector, the LOE comprising:
a first major external surface and a second major external surface, the first and second major external surfaces being mutually parallel, the image illumination from the image projector propagating by internal reflection at the major external surfaces,
a first region containing a first optical aperture expansion configuration including a first set of planar, mutually-parallel, partially reflecting surfaces having a first orientation,
a second region containing a second optical aperture expansion configuration including a second set of planar, mutually-parallel, partially reflecting surfaces having a second orientation non-parallel to the first orientation, and
an intermediate region, located between the first and second regions, having a diffractive optical aperture expansion configuration including a first diffractive element located at the first major external surface and a second diffractive element located at the second major external surface such that the first and second diffractive elements are parallel,
wherein the major external surfaces extend across the first and second regions such that both the first set of partially-reflecting surfaces and the second set of partially-reflecting surfaces are located between the major external surfaces, and wherein the optical aperture expansion configurations are configured such that,
image illumination injected into the LOE that propagates by internal reflection at the major external surfaces is deflected by the first optical aperture expansion configuration to the intermediate region so as to expand an optical aperture of the image projector in a first dimension, where the image illumination is deflected by the diffractive optical aperture expansion configuration to the second region so as to further expand the optical aperture of the image projector in the first dimension, and where the image illumination is deflected by the second optical aperture expansion configuration so that the image illumination is coupled out of the LOE toward the eye-motion box and the optical aperture of the image projector is expanded in a second dimension.

18. A light-guide optical element (LOE) for directing image illumination from an image projector to an eye-motion box for viewing by an eye of a user, the LOE formed from transparent material and comprising:
a first region containing a first set of planar, mutually-parallel, partially reflecting surfaces;
a second region containing a second set of planar, mutually-parallel, partially reflecting surfaces;
a third region containing a third set of planar, mutually-parallel, partially reflecting surfaces; and
a pair of mutually-parallel major external surfaces, the major external surfaces extending across the first region, the second region, and the third region such that the first, second, and third sets of partially-reflecting surfaces and the second set of partially-reflecting surfaces are located between the major external surfaces, the image illumination from the image projector propagating by internal reflection at the major external surfaces,
wherein the third set of partially reflecting surfaces are oriented non-parallel to the first set of partially reflecting surfaces, and wherein the second set of partially reflecting surfaces are oriented non-parallel to the third set of partially reflecting surfaces, and wherein the first set of partially reflecting surfaces, the second set of partially reflecting surfaces, and the third set of partially reflecting surfaces are configured such that,
image illumination injected into the LOE that propagates by internal reflection at the major external surfaces is deflected by the first set of partially reflecting surfaces to the second region so as to expand an optical aperture of the image projector in a first dimension, where the image illumination is deflected by the second set of partially reflecting surfaces to the third region so as to further expand the optical aperture of the image projector in the first dimension, and where the image illumination is deflected by the third set of partially reflecting surfaces so that the image illumination is coupled out of the LOE toward the eye-motion box and the optical aperture of the image projector is expanded in a second dimension.

19. The LOE of claim 18, wherein the second set of partially reflecting surfaces are perpendicular to the major external surfaces.

20. The LOE of claim 18, wherein the second set of partially reflecting surfaces are oblique to the major external surfaces.
